(19) United States
(12) Patent Application Publication
(10) Pub. No.: US 2023/0023947 A1
(43) Pub. Date: Jan. 26, 2023

(54) METHOD OF PRODUCING COATED ELECTRICAL STRIP AND COATED ELECTRICAL STRIP

(71) Applicant: voestalpine Stahl GmbH, Linz (AT)

(72) Inventors: Ronald FLUCH, Linz (AT); Roland BRAIDT, Hellmonsoedt (AT)

(73) Assignee: voestalpine Stahl GmbH, Linz (AT)

(21) Appl. No.: 17/782,396

(22) PCT Filed: Nov. 30, 2020
(86) PCT No.: PCT/EP2020/083866

§ 371 Date: Jun. 3, 2022

(30) Foreign Application Priority Data
Dec. 12, 2019 (DE) 10 2019 134 136.1

(51) Int. Cl. C09D 183/06

(52) U.S. Cl. CPC C09D 183/06

(57) ABSTRACT

A method of producing a coated electrical strip includes hydrolyzing a surface of a rolled aluminum-alloyed electrical strip. A pretreatment layer containing an organosilicon compound is applied over the surface of the rolled aluminum-alloyed electrical strip. Subsequently, the rolled aluminum-alloyed electrical strip coated with the pretreatment layer is coated with a baking varnish layer.

### CROSS-REFERENCE TO RELATED APPLICATIONS

This application is a U.S. national stage of International Application No. PCT/EP2020/083866, filed on Nov. 30, 2020. The International Application claims the priority benefit of German Patent Application No. 102019134136.1, filed on Dec. 12, 2019. Both International Application No. PCT/EP2020/083866 and German Patent Application No. 10 2019 134 136.1 are incorporated by reference herein in their entirety.

### TECHNICAL FIELD

The invention relates to a method of producing a coated electrical strip and to a coated electrical strip.

### BACKGROUND

Coated electrical strips are used in the electrical industry, where they form the starting material in the construction of electrical cores used in generators, electric motors, transformers or other electrical equipment. Such electrical cores are manufactured by cutting the coated electrical strip into individual sheet metal lamellas, stacking the sheet metal lamellas and joining (e.g. bonding) them to form a lamella package. The layered structure largely prevents the occurrence of eddy currents in the electrical core, which significantly increases the efficiency of the electrical core.

Depending on the application, electrical sheets of different steel alloys, soft magnetic properties, power dissipation, thickness and other properties important depending on the application are selected.

It is already known to coat the electrical strip with a layer of baking varnish during production. Baking varnish layers are insulating varnish layers which ensure electrical insulation of the electrical lamellas in the stack of sheets and are also adhesive, i.e. in addition to insulation they also allow bonding of the electrical lamellas in the stack of sheets. Baking varnish layers contain an adhesive which is activated during the bonding process (so-called bonding of the stacked electrical lamellas to forma lamella package) and gives the lamella package the required dimensional stability.

Since the baking varnish layers reduce the electrically effective volume of an electrical core, the aim is to achieve the thinnest possible layer thicknesses for high efficiency. On the other hand, the layer thickness must be sufficiently large to be able to guarantee the required insulation safety over the lifetime of the electrical core.

Existing coating systems apply the baking varnish layer to the cleaned (washed and brushed) bare electrical strip. Baking varnish adhesion is improved by cleaning the electrical strip.

In practice, the cooling of bonded lamella packages presents a complex problem. Numerous possible solutions have been discussed in the past, including the use of cooling ducts, cooling media, etc. A concrete, practical solution is not yet known. Difficulties are caused in particular by the infiltration of the baking varnish layers by moisture as a result of insufficient wet adhesion.

Particularly in the case of higher-alloyed electrical strips, sufficient adhesion of the baking varnish layer to the electrical strip can often not be guaranteed.

### SUMMARY

One of the objects underlying the invention can be seen in the provision of a method of producing a coated electrical strip which enables baking varnish coatings with good wet adhesion and thus good coolant resistance. In particular, the method should be simple and inexpensive to carryout and should furthermore enable low coating thicknesses.

A further aspect of the object can be seen in the provision of a method and a product manufactured with it, which leaves the conventional manufacturing method at the customer (including cutting the lamellas to size and bonding them into a dimensionally stable lamella package) as unaffected as possible.

Accordingly, a method of producing a coated electrical strip comprises hydrolyzing a surface of a rolled aluminum-alloyed electrical strip. A pretreatment layer containing an organosilicon compound is applied over the surface of the rolled aluminum-alloyed electrical strip. Subsequently, the rolled aluminum-alloyed electrical strip coated with the pretreatment layer is coated with a baking varnish layer.

A coated electrical strip includes a rolled aluminum-alloyed electrical strip and a pretreatment layer containing an organosilicon compound over the surface of the rolled aluminum-alloyed electrical strip, and a baking varnish layer over the pretreatment layer.

Such a coated electrical strip can exhibit high coating quality in terms of wet adhesion and coolant resistance of the baking varnish layer. These advantages may be particularly effective when using higher alloy electrical strips, which offer poorer conditions for conventional good baking varnish adhesion but particular suitability for the present invention.

### BRIEF DESCRIPTION OF THE DRAWINGS

In the following, examples of embodiments and further developments are explained in an exemplary manner on the basis of the schematic drawings, whereby a different degree of detail is used in the drawings in some cases. Identical reference signs designate the same or similar parts.

FIG. 1 shows a longitudinal sectional view of an exemplary method of applying a pretreatment layer and a baking varnish layer over the pretreatment layer on an electrical strip, as well as drying of the layers in drying equipment.

FIG. 2 illustrates hydrolysis of the surface of the electrical strip.

FIG. 3 illustrates the mode of action of organosilicon compounds as a molecular bridge between the hydrolyzed surface of the electrical strip and the organic baking varnish before and after the formation of covalent bonds.

FIG. 4 shows a longitudinal section of an example near-surface section of an electrical strip after layer drying.

FIG. 5 is a schematic representation of a detailed view from FIG. 4.

FIG. 6 shows a coil of a coated electrical strip according to one embodiment.

FIG. 7 shows a stack of electrical strip sheets made up of coated electrical strip lamellas stacked on top of each other.

### DETAILED DESCRIPTION

In this description, terms such as “applying” or “depositing” and similar terms (e.g., “applied” or “deposited”) are generally not to be understood to mean that the applied or deposited layers must have direct contact with the surface to which they are applied or deposited. There maybe intervening elements or layers between the “applied” or “deposited”, elements or layers and the underlying surface. However, the above or similar terms in this disclosure may also have the specific meaning that the elements or layers have direct contact with the underlying surface, i.e., that there are no intervening elements or layers.

The term “over” as used with respect to an element or layer of material formed or applied “over” a surface may be used herein with the meaning that the element or layer of material is applied “indirectly on” the surface, wherein intervening elements or layers maybe present between the surface and the element or layer of material. However, the term “over” may also have the specific meaning that the element or layer of material applied or deposited “over” a surface is applied “directly on”, e.g., in direct contact with, the surface in question. The same applies analogously to similar terms such as “overlying”, “under”, “underlying”, etc.

In the method disclosed herein, the organosilicon compound acts as an adhesion promoter between the aluminum-alloyed electrical strip and the baking varnish (Backlack) layer. In particular, it increases the wet adhesion of the baking varnish layer to the surface of the rolled aluminum-alloyed electrical strip. This reduces the tendency to infiltration and ensures coolant resistance in the subsequent product (lamella package). This is achieved by the organosilicon compound being able to form covalent bonds with both the baking varnish and the hydrolyzed surface of the rolled aluminum-alloyed electrical strip.

By selective hydrolysis of the surface of the rolled aluminum-alloyed electrical strip, a surface-adjacent AIN layer of the electrical strip is transformed into a defined Al(OH)₃ surface. This Al(OH)₃ surface is ideal for covalent bonding to a (first) functional group of the organosilicon compound. This means that the increased wet adhesion of the baking varnish layer is based, among other things, on the interaction of the (at least partially) hydrolyzed surface of the aluminum-alloyed electrical strip with the chemical properties of the organosilicon compound. This may involve hydrolysis of the entire electrical strip surface, i.e. preferably full-surface hydrolysis, since it enables covalent bonds to be formed between the electrical strip surface and the organosilicon compound over the entire electrical strip surface.

Preferably, the organosilicon compound is an organosilane. Organosilanes, also known as organofunctional silanes, are hybrid compounds that combine the inorganic functionality of an alkyl silicate with the functionality of a reactive organic group. This special property enables their use as molecular bridges between the (inorganic) surface of the aluminum-alloyed electrical strip and the (organic) baking varnish.

The organosilicon compound may further be a substance from the group of organosilanols, siloxanes or silicones.

To achieve the hydrolyzable surface of the electrical strip, the dew point can be set in the range of −35° C. to −60° C., especially lower than −45° C., during annealing of the electrical strip. By setting a low dew point (i.e. a dry environment through an annealing atmosphere with low H₂O content), favorable conditions are created for sufficient AIN to be available on the surface of the electrical strip for hydrolysis.

Furthermore, an annealing end temperature in the range of 1000° C. to 1200° C., in particular greater than 1100° C., can be set. The annealing end temperature also influences the trade-off between surface oxidation and surface nitriding of the Al-containing electrical strip. The higher the annealing end temperature and the lower the dew point, the more AIN is available at the surface for hydrolysis.

For example, the pretreatment layer may consist of a composition containing 1.0% wt to 3.0% wt organosilane (e.g., 3-glycidyloxy propyltrimethoxysilane), 0.5% wt to 2.0% wt co-solvent (e.g., butylglycol), 0.05% wt to 0.3% wt surfactant (e.g., Ligaphob N90), the balance an organic or inorganic solvent and/or water.

The pretreatment layer may further contain a film-forming resin (so-called film former), e.g. 0.1% wt to 2.0% wt phenoxy dispersion. This can favorably influence the layer properties of the pretreatment layer during application and drying. However, it is also possible to apply the pretreatment layer without a film former.

The layer thickness of the dried pretreatment layer can be very thin and, for example, only between 10 and 100 nm, in particular 20 and 50 nm. Because of its low layer thickness, the pretreatment layer contributes only insignificantly to the overall thickness of the coating process. It is assumed that the use of the pretreatment layer does not require an increase in the overall coating thickness compared to previous applications. Therefore, it is expected that there will be no degradation in the efficiency of the electrical cores made from the electrical strip of the invention compared to conventional electrical cores.

After application of the pretreatment layer and before coating with the baking varnish layer, active drying of the pretreatment layer can be carried out by supplying energy. Active drying is carried out by supplying additional energy, for example in the form of radiation or convection heat. Due to the low layer thickness of the pretreatment layer, a relatively short-time and/or low-energy energy supply may be sufficient. Active drying increases the process reliability of the coating process.

For example, the pretreatment layer is applied by roller application using a first roller. Other application methods, such as printing methods or spraying methods, are also possible.

When using an existing coating system with two coating stations connected in series in the inline process, the process can be implemented very cost-effectively in the manufacturing plant by converting the first coating station in the strip run for coating with the pretreatment layer, while the baking varnish layer is then applied in the second coating station using only a single roller application. If necessary, only the (first) drying system between the two roller applications needs to be retrofitted.

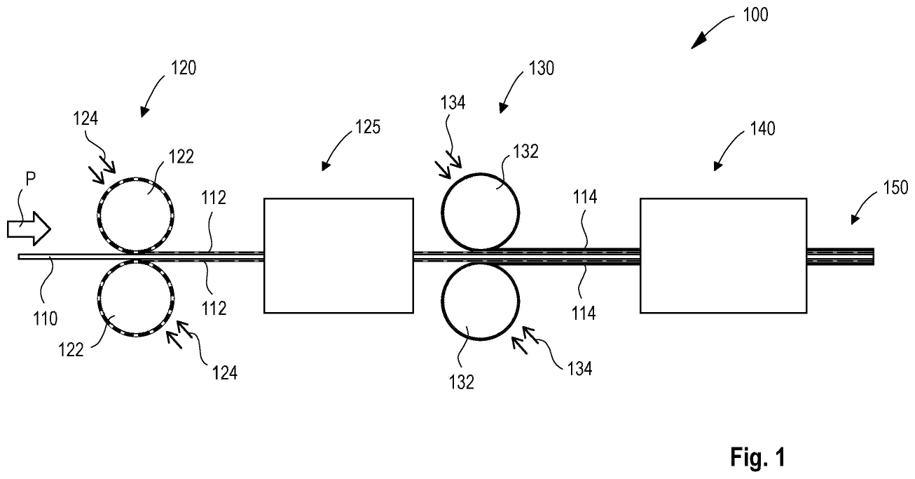

FIG. 1 shows an example of a method of producing a coated electrical strip 150 from a rolled, aluminum-alloyed electrical strip (electrical steel strip) 110 in a strip coating system 100. The electrical strip 110 is fed to the strip coating system 100 in a continuous strip run (see arrow P). The electrical strip 110 maybe, for example, a cold-rolled, non-grain-oriented electrical sheet (electrical steel sheet) in the finally annealed condition (e.g. DIN EN 10106). Other electrical (steel) sheets, for example hot-rolled and/or non-finish annealed electrical sheets, etc., are also possible. Cold-rolled or hot-rolled electrical sheets are used, for example, as pole sheets in exciter machines and generators or in transformers, etc.

In particular, the invention is directed to the coating of high-alloy or ultra-high-alloy electrical strips having, for example, a total alloy content equal to or greater than 4% wt. For example, such electrical strips may have a silicon content equal to or greater than 3% wt and an aluminum content equal to or greater than 1% wt, for example.

Prior to application of the pretreatment layer, the rolled electrical strip can be cleaned by washing and/or brushing or other mechanical and/or chemical cleaning steps to provide a bare metal surface that is as free of foreign matter as possible.

For example, the electrical strip 110 fed to the strip coating system 100 may be in the form of an “endless” metal strip, which may be unwound from a coil (not shown) in the direction of the arrow P.

The strip coating system 100 includes at least a pretreatment station 120 and a coating station 130. A pretreatment layer drying system 125 may be provided in the strip path between the pretreatment station 120 and the coating station 130. Further, the strip coating system 100 may include a baking varnish drying system, such as a dry curing oven 140, in the strip path downstream of the second coating station 130.

In the example shown here, the coating system 100 is designed as a double-sided coating system 100. However, it is also possible that only one flat side of the electrical strip 110 (for example the upper side shown in FIG. 1) is coated. In this respect, all the details given below apply both to the case of single-sided coating and to the illustrated possibility of coating the electrical strip 110 on both flat sides. In the second case (coating on both sides), all details regarding pretreatment, coating and drying can apply both to the processing of the upper side of the strip and to the processing of the opposite lower side of the electrical strip 110. Furthermore, pretreatment and coating on both sides can also be carried out with different layers on the two sides of the strip.

The rolled aluminum-alloyed electrical strip 110 may include an Al content equal to or greater than 0.5% wt, 1.0% wt, 1.1% wt, or 1.3% wt and equal to or less than 2.0% wt or 2.5% wt.

In particular, the rolled aluminum-alloyed electrical strip 110 may have a Si content equal to or greater than 0.5% wt, 1.5% wt, 1.7% wt, or 1.8% wt and equal to or less than 2.4% wt or 2.8% wt.

The total alloy content (of Si and Al, possibly including other alloying elements) maybe equal to or greater than 1.0% wt , 2.0% wt , 3.0% wt, or 3.5% wt, and equal to or less than 3.7% wt, 3.8% wt, 4.0% wt , or 5. 0% wt . In particular, ultra-high alloy grades can also be used as electrical strip 110, which typically exhibit relatively poor baking varnish adhesion.

The electrical strip 110 may be a steel strip having, in particular, the following composition (all figures in % wt):

C: 0.0010 - 0.02

Si: 0.5 - 4.0

Mn: 0.1 - 0.5

P: 0.01 - 0.02

S: 0.0001 - 0.005

Al: 0.5 - 2.5

N: <0.005

Nb: <0.5

Ti: <0.5

B: <0.0020

Cr: <0.10

Cu: <0.10

V: <0.10

Sn: <0.10

Mo: <0.10

balance iron and unavoidable impurities.

Preferred areas that may be used individually or in combination in electrical strip 110 are:

C: 0.0020 - 0.0050

Si: 2.0 - 3.0 (special range: 2.27 - 2.37)

Mn: 0.25 - 0.3

P: 0.01 - 0.02

S: 0.0001 - 0.005

Al: 0.8 - 1.3 (special range: 1.0 - 1.1)

N: <0.005

Nb: <0.1

Ti: <0.1

B: <0.0020

Cr: <0.05 (special range: <0.05)

Cu: <0.05

V: <0.05

Sn: <0.05

Mo: <0.05

balance iron and unavoidable impurities.

An example of an electrical (steel) strip is given below. The values were obtained by chemical analysis:

### EXAMPLE

### Electrical strip

C: 0.0038

Si: 2.3

Mn: 0.28

P: 0.013

S: 0.0008

Al: 1.00

N: 0.001

balance iron and unavoidable impurities.

An example of the combination of grades and annealing parameters of an electrical strip is given below. Furthermore, possible ranges of the mentioned quantities are added to the example in brackets.

Grade

| | | |
|---|---|---|
| A1: | 1.0% wt | (range: 0.5-2.5% wt) |
| Si: | 2.3% wt | (range: 0.5-4.0% wt) |

Annealing

| | |
|---|---|
| Annealing end temperature | (range: 800-1200° C., |
| T = 1,000° C. | preferably 920-1150° C.) |
| Annealing time t = 2 min | (range : 0.5-5 min) |
| Dew point = −45° C. | (range: -35-60° C.) |

The uncoated electrical strip 110, which may have been chemically and/or mechanically cleaned, is coated with a pretreatment layer 112 in the pretreatment station 120. The coating may be applied over the entire surface, i.e., the pretreatment layer 112 may completely cover the surface of the electrical strip 110. The pretreatment layer 112 may be applied directly to the steel surface of the electrical strip 110.

The pretreatment layer 112 may be applied to the upper flat side (or also to the opposite lower flat side) of the electrical strip 110 by a roller 122 (or a pair of rollers 122). In a roller application, the roller 122 runs on the moving electrical strip 110, depositing a liquid pretreatment substance 124 previously applied to the roller 122 in the form of a thin film on the surface of the electrical strip 110. In this regard, the film thickness of the wet pretreatment layer 112 can be adjusted by the parameters of the roller application. The wet film thickness of the pretreatment layer 112 before drying can be in the range of 1 to 10 μm, preferably 2 to 4 82 m. At a higher film thickness, the solution is more diluted and can therefore be more homogeneously distributed, while at a thinner film thickness, the individual components of the pretreatment layer 112 are less diluted in the wet film and can therefore be metered more precisely.

The pretreatment coating 112 serves to increase the wet adhesion of the baking varnish 134 to the electrical strip 110. Generally, alloyed electrical strips 110 show an increased formation of aluminum and/or silicon oxides on the surface, which negatively affects the adhesion of the baking varnish layer 114 to the electrical strip 110. The pretreatment layer 112 provides the baking varnish layer 114 with an improved adhesion base. For this purpose, the accumulation of aluminum near the strip surface (which is in itself detrimental to good adhesion) is utilized by inhibiting the formation of aluminum oxide, promoting the formation of aluminum nitride and creating a substrate for the baking varnish layer 114 that is specifically suitable for improved wet adhesion by the combination of hydrolyzing the surface of the electrical strip 110 and using an organosilicon compound in the pretreatment substance 124.

The pretreatment layer 112 can be relatively thin and have a thickness of about 10 nm to 100 nm when dried. In particular, thicknesses below 50 nm can be set and already enable a significant improvement in varnish adhesion.

After application of the pretreatment layer 112 to one or both sides of the electrical strip 110, the pretreated electrical strip 110 passes through the (optional) pretreatment layer drying system 125, which may be designed as a continuous drying system that heats the electrical strip 110 or the pretreatment layer 112 thereon to relatively low temperatures in the range of, for example, 40° C. to 50° C. (e.g., about 45° C.). In other words, the deliberate, active drying is merely a “flashing off” or “drying on” of the pretreatment layer 112. It has been shown that the process reliability of the coating process can be significantly increased by flashing off or drying on of the pretreatment layer 112.

Subsequently, the pre-coated electrical strip 110 enters the coating station 130. At the coating station 130, for example, a roller 132 (ora pair of rollers 132) applies the wet baking varnish layer 114 to the pretreatment layer 112. The layer thickness (measured after drying) can be adjusted relatively precisely by parameters of the roller application. Also, the baking varnish coating 114 can be full coverage, i.e., can completely cover the surface of the pretreatment layer 112.

A baking varnish layer (Backlack layer) is a thermosetting water-based hotmelt varnish layer comprising, for example, an epoxy resin or an epoxy resin mixture and at least one latent hardener (curing agent) such as dicyandiamide. A hardener turns a thermoplastic into a thermoset. The baking varnish layer enables electrical strip lamellas cut out of the electrical strip to be baked together to form a dimensionally stable electrical core.

The baking varnish 134 may allow dry bonding of the electrical sheet lamellas in the electrical core without additional bonding means (such as welded joints).

For example, baking varnishes of insulation classes C3/EC-3, C4/EC-4, C5/EC-5, or C6/EC-6 can be used.

Baking varnishes 134 of insulation class C3/EC-3 are unfilled organic-based varnishes which may contain purely organic components and are used for insulating electrical strip lamellas which are not subjected to any further annealing process. These varnishes exhibit excellent die-cutting properties.

Baking varnishes 134 of insulation class C4/EC-4 are inorganic insulating varnishes that are resistant to annealing and have good welding properties. These inorganic, water-thinnable baking varnishes prevent electrical sheets from sticking together during annealing.

Baking varnishes 134 of insulation class C5/EC-5 are unfilled organic or inorganic-based varnishes for applications requiring higher insulating properties, heat resistance and, if necessary, improved weldability.

Baking varnishes 134 of insulation class C6/EC-6 are filled varnishes on an organic or inorganic basis that offer further improved insulating properties and increased compressive strength. These varnishes are based on thermally stable, organic polymers with a high proportion of inorganic fillers. They are used in particular for large electrical cores with high pressure and temperature loads.

The baking varnish layer 114 may be applied directly to a surface of the previously applied pretreatment layer 112.

For example, the layer thickness of the baking varnish layer 114 may be between 1 and 12 μm. In particular, the layer thickness of the baking varnish layer 114 may be equal to or less than 6 μm, 4 μm, 2 μm, or 1 μm.

For example, with the different coating on both sides, a different baking varnish layer 114 can be applied to the lower side of the electrical strip 110 than to the upper side. For example, a baking varnish layer can be applied to the upper side (upper side) and an insulating varnish layer without adhesive properties can be applied to the upper side (lower side).

The pretreatment station 120 and the coating station 130 may be spaced apart spatially and, relative to the strip travel speed, temporally. For example, it may be provided that the spatial distance between the pretreatment station 120 and the second coating station 130 (i.e., for example, the distance between the axes of the rollers 122 and 132) is equal to or less than 10 m, 8 m, 6 m, 5 m, or 4 m. The time period between the application of the pretreatment layer 112 in the pretreatment station 120 and the application of the baking varnish layer 114 in the coating station 130 may be equal to or less than 20 s, 15 s, 10 s, 5 s, or 3 s. For example, typical strip speeds may be in the range of 100 m/min, although this value may vary by, for example, ±10%, +20%, +30%, +40%, or +50%.

For example, in the strip path downstream of the coating station 130 is the drying oven 140. The temporal and spatial distance between the second coating station 130 and the entry into the drying oven 140 may have, for example, the same values as mentioned above for the temporal and spatial distance between the pretreatment station 120 and the coating station 130.

Drying of the baking varnish layer 114 takes place in the drying oven 140. For this purpose, the drying oven 140 may be designed as a continuous drying oven (tunnel oven) through which the coated electrical strip 110 continuously passes. For example, the maximum temperature of the electrical strip 110 in the drying oven 140 maybe between 150° C. and 300° C., and in particular temperature values equal to or greater than 170° C., 180° C., 190° C., 200° C., 210° C., 220° C., or 230° C. and/or equal to or less than 250° C., 220° C., 210° C., 200° C., or 190° C. may be provided.

For example, the duration of the heat treatment in the drying oven 140 may be between 10 s and 40 s and, in particular, may be less than, equal to or greater than 20 s or 30 s. Other temperatures and heat treatment durations are also possible.

In the drying oven 140, a chemical bond (covalent bond) is formed between the pretreatment layer 112 and the baking varnish layer 114, as will be described in more detail below. This increases the adhesion. The baking varnish layer 114 is dried at least to the extent that it is mechanically stable and abrasion resistant when bonded to the electrical strip 110 in the strip path downstream of the drying oven 140. This then enables further handling of the dried, coated electrical strip 150 in the strip path downstream of the drying oven 140, for example by means of deflection rollers or by winding into a coil (not shown in FIG. 1.

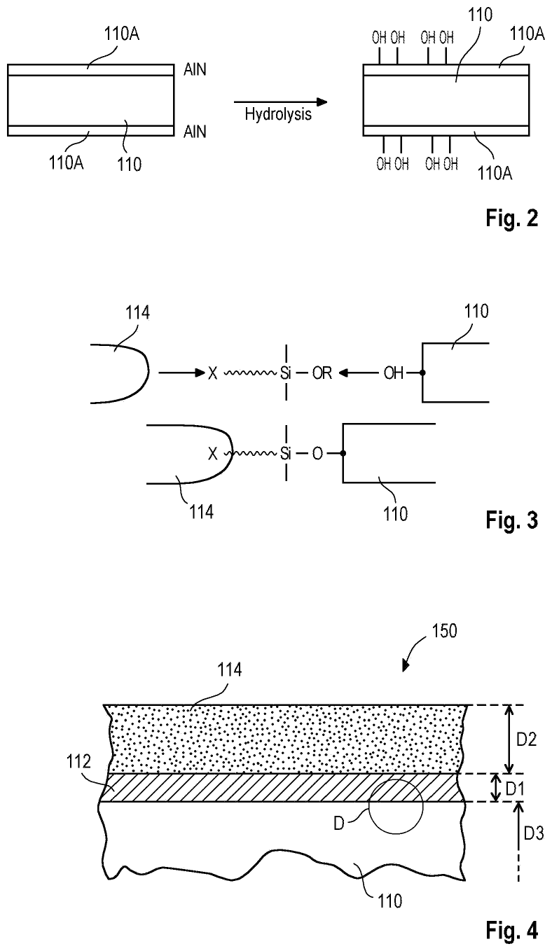

FIG. 2 shows a schematic representation of a (at least partial) hydrolysis of the surface of the electrical strip 110.

As already mentioned, an alloyed electrical strip 110 has a region 110A (shown enlarged) on its surface in which an accumulation of the alloying constituents, in the present case in particular of aluminum, occurs. In order to create a hydrolyzable surface of the electrical strip 110, it is necessary to prevent the formation of aluminum oxide there as far as possible and instead provide AIN in the surface layer 110A. If the dew point is sufficiently low (e.g. −45° C.) and the annealing end temperature is relatively high (e.g., equal to or greater than 1000° C. or 1100° C.), it can be achieved that the nitrogen dissociates from the air and forms the compound AIN with the aluminum in the surface layer 110A. In this way, the near-surface AlN-containing surface layer 110A shown in the left part of FIG. 2 is provided.

Hydrolysis of the AlN-containing surface layer 110A of the electrical strip 110 then generates the hydroxy group (—OH) on the metal surface of the electrical strip 110, see the right part of FIG. 2. Hydrolysis preferably occurs over the entire surface of the metal in a “covering” manner. However, it is not necessary that every AlN compound is hydrolyzed, especially if it is not directly adjacent to the surface. I.e., even partial or predominant hydrolysis can potentially bring about a sufficiently high surface coverage with hydroxy groups.

Hydrolysis of the electrical strip 110 may occur prior to coating with the pretreatment layer 112, or may still occur in the time window between application of the pretreatment layer 112 and drying in the pretreatment layer drying system 125.

Depending on the AIN content of the AlN-containing surface layer 110A, it may be possible to provide a sufficiently hydrolyzed surface of the electrical strip 110 by humidity alone. However, hydrolysis can also be selectively induced by applying a suitable substance to the strip surface. A first possibility is to apply the substance (e.g., a weakly alkaline solution, but hydrolysis is also possible in an acidic environment) to the electrical strip 110 in the strip run before the pretreatment station 120. A second possibility is to perform the hydrolysis “in-situ” quasi simultaneously with the deposition reaction in the time window between the application of the pretreatment layer 112 and the layer drying in the pretreatment layer drying system 125.

FIG. 3 explains the mode of action of an organosilicon compound as a molecular bridge between the hydrolyzed surface layer 110A of the electrical strip 110 and the organic baking varnish 114.

In FIG. 3, R denotes a hydrolyzable functional group (e.g., alkoxy group) available for reaction with the hydrolyzed metallic electrical strip 110. X denotes a generally non-hydrolyzable organofunctional group that enables chemical bonding of the organosilicon compound to the baking varnish 114. Between the silicon atom and the organofunctional group X is a carbon chain of variable formation and length. The carbon chain may be, for example, ether groups—an oxygen atom substituted with two organyl radicals—or other organic chains.

In the lower part of FIG. 3, the bridging function of the organosilicon compound is shown. As already mentioned, the organosilicon compound reacts with the hydroxy groups on the metal surface to form covalent Si—O bonds. This deposition reaction is also referred to as hydrolysis-condensation. The Si—O bond exhibits high chemical and thermal stability, making the compound largely inert to chemical and medial influences from the environment. This is one reason for the increased wet adhesion.

It can be assumed that the deposition reaction proceeds rapidly, i.e. already starts when the organosilicon compound (contained in the pretreatment layer) is applied and takes place in particular during active drying, which then increases process reliability.

A covalent bond is also formed between the baking varnish 114 and the organosilicon compound. By a specific selection of the organofunctional group X (e.g. amino groups or epoxy groups) , the organosilicon compound can form excellent covalent bonds with the baking varnish 114 (see FIG. 3, lower part) .

For example, to prepare a pretreatment substance 124, the following ingredients may be mixed together in the ranges of amounts indicated below:

Organosilane (e.g. GLYMO): 0.5-3.0% wt

Film former (e.g. phenoxide dispersion) 0.0-2.0% wt

Co-solvent (e.g. butyl glycol): 0.2-2.0% wt

Surfactant (e.g. Ligaphob N90): 0.02-0.3% wt

Rest: organic or inorganic solvent

Preferred amount ranges:

Organosilane (e.g. GLYMO): 1.0-2.5% wt

Film former (e.g. phenoxy dispersion) 0.0-1.5% wt

Co-solvent (e.g. butyl glycol): 0.5-1.3% wt

Surfactant (e.g. Ligaphob N90): 0.05-0.22% wt

Rest: organic or inorganic solvent

### Composition Examples

### Example 1: with Film Former (Resin):

| Component: | % wt |
|---|---|
| GLYMO (3-glycidyloxypropyltrimethoxysilane) | 2.0 |
| PKHW-34 (phenoxy dispersion) | 1.0 |
| Butyl glycol (co-solvent) | 1.0 |
| Ligaphob N90 (surfactant) | 0.2 |
| Water | 95.8 |

### Example 2: without Film Former (Resin):

| Component: | % wt |
|---|---|
| GLYMO (3-glycidyloxypropyltrimethoxysilane) | 2.0 |
| Butyl glycol (co-solvent) | 1.0 |
| Ligaphob N90 (surfactant) | 0.2 |
| Water | 96.8 |

In particular, the pretreatment substance 124 may be free of any hardener or baking varnish.

FIG. 4 shows a simplified longitudinal cross-sectional view of a near-surface section of the coated electrical strip 110 in the area downstream of the drying oven 140. Layer thickness variations are not shown. The cross-sectional view may be identical to the longitudinal view shown.

The (dry) pretreatment layer 112 has a thickness D1 and the (dry) baking varnish layer 114 has a thickness D2. For example, the layer thickness D1 maybe smaller than the layer thickness D2 by a factor equal to or greater than 10, 25, or 50. For example, the layer thickness D2 may be equal to or greater than or less than 2 μm, 3 μm, 4 μm, 5 μm, 6 μm, 7 μm, 8 μm, 9 μm, 10 μm, 11 μm, or 12 μm. For example, the sheet thickness D3 of the electrical strip 110 may be equal to or less than 0.5 mm, 0.4 mm, 0.35 mm, or 0.3 mm.

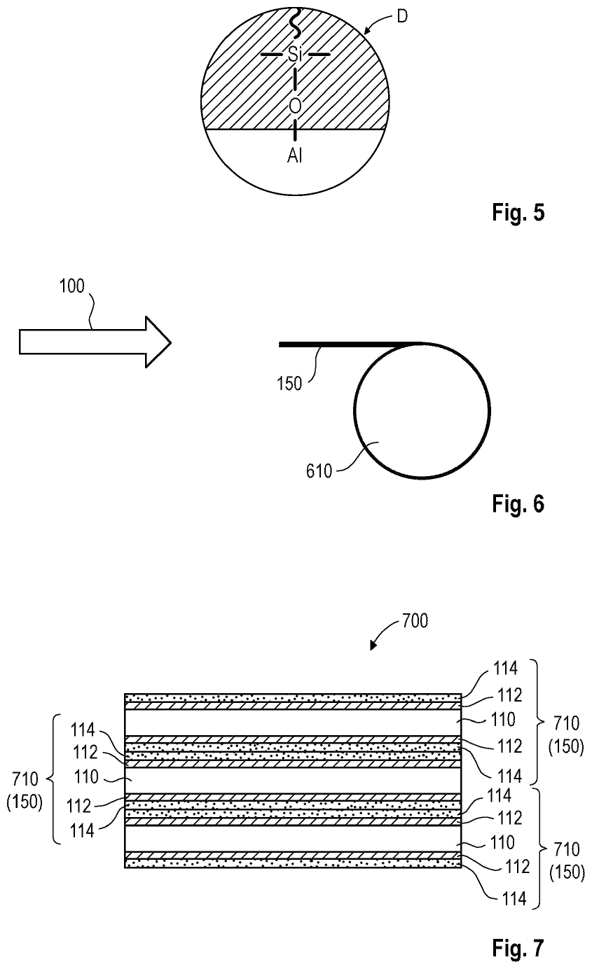

FIG. 5 shows in schematic representation a detail D of FIG. 4. In the area of the surface of the electrical strip 110, a covalent Si—O bond is shown which binds to an aluminum atom near the surface in the electrical strip 110.

FIG. 6 illustrates a coil 610 of the coated electrical strip 150 as it may be wound up on the output side of the strip coating system 100. The coil 610 can, for example, be delivered to the customer for further processing into the electrical core (possibly with integrated cooling channels).

FIG. 7 shows in schematic view a section of an electrical core 700 implemented by stacking electrical sheets 710 obtained by transversely dividing the coated electrical strip 150.

Typically, before stacking, the electrical sheets 710 are formed into their final shape by a shape cutting operation, such as punching or laser cutting.

The stack of sheets is consolidated into the dimensionally stable electrical core 700 by curing the baking varnish layers 114. The solidification mechanism is based on a chemical reaction, typically a three-dimensional cross-linking of the adhesive in the baking varnish layer 114. The curing of the baking varnish can be accomplished by clamping the layered electrical sheets 710 and heating the stack of layers, for example in an oven.

In the example shown here, an electrical core 700 is shown that is made of an electrical sheet 710 coated on both sides. As mentioned above, electrical sheets 710 coated on one side or electrical sheets 710 coated differently on both sides may also be used, whereby higher stacking factors maybe achievable. FIG. 7 is not to scale due to exaggerated thicknesses of the pretreatment layers 112.

In particular, it may be envisaged to provide such electrical cores 700 with cooling channels in the bonded lamella package. As a result of the measures described here, the risk of corrosion due to infiltration of the baking varnish layers 114 by moisture is significantly reduced, and higher-alloyed and highest-alloyed electrical strips can also be used for cooling applications.

Although specific examples have been illustrated and described herein, it will be appreciated by those of ordinary skill in the art that a variety of alternate and/or equivalent implementations maybe substituted for the specific examples shown and described without departing from the scope of the present invention. This application is intended to cover any adaptations or variations of the specific examples discussed herein. Therefore, it is intended that this invention be limited only by the claims and the equivalents thereof.

1. A method of producing a coated electrical strip, comprising:
hydrolyzing a surface of a rolled aluminum-alloyed electrical strip;
applying a pretreatment layer over the surface of the rolled aluminum-alloyed electrical strip, the pretreatment layer comprises an organosilicon compound; and
coating of the rolled aluminum-alloyed electrical strip coated with the pretreatment layer with a baking varnish layer.

2. The method of claim 1, wherein the organosilicon compound is an organosilane.

3. The method of claim 1, wherein the organosilicon compound is an organosilanol.

4. The method of claim 1, wherein the organosilicon compound is a siloxane or a silicone.

5. The method of claim 1, wherein the organosilicon compound comprises a first functional group and a second functional group, wherein the first functional group forms a covalent bond with the hydrolyzed surface and the second functional group forms a covalent bond with the baking varnish.

6. The method of claim 5, wherein the first functional group is an alkoxy group.

7. The method of claim 5, wherein the covalent bond of the first functional group is a Si—O bond.

8. The method of claim 5, wherein the second functional group is an amino group or an epoxy group.

9. The method of claim 1, wherein an annealing of the electrical strip is carried out prior to the hydrolyzing, wherein the dew point is set in the range of −35° C. to −60° C. during the annealing of the electrical strip.

10. The method of claim 1, wherein an annealing of the electrical strip is carried out prior to the hydrolyzing, wherein an annealing end temperature in the range of 1000° C. to 1200° C. is set.

11. The method of claim 1, wherein the pretreatment layer is prepared from a composition containing 0.5% wt to 3.0% wt organosilane, 0.2% wt to 2.0% wt co-solvent, 0.02% wt to 0.3% wt surfactant, the balance an organic or inorganic solvent and/or water.

12. The method of claim 1, wherein the pretreatment layer further comprises a film-forming resin.

13. The method of claim 1, wherein the layer thickness of the dried pretreatment layer is between 10 and 100 nm.

14. The method of claim 1, wherein, after application of the pretreatment layer and before coating with the baking varnish layer, active drying of the pretreatment layer is carried out by supplying energy.

15. The method of claim 1, wherein the pretreatment layer is applied by a roller application using a first roller.

16. The method of claim 1, wherein the baking varnish layer is applied by a roller application using a second roller.

17. A coated electrical strip, comprising:
a rolled aluminum-alloyed electrical strip;
a pretreatment layer comprising an organosilicon compound over the surface of the rolled aluminum-alloyed electrical strip; and
a baking varnish layer over the pretreatment layer.

18. The coated electrical strip of claim 17, wherein the organosilicon compound is an organosilane, organosilanol, siloxane or a silicone.

19. The coated electrical strip of claim 17, wherein the pretreatment layer comprises a film-forming resin.

20. The coated electrical strip of claim 17, wherein the pretreatment layer does not comprise a film-forming resin.

21. The coated electrical strip of claim 17, wherein covalent Si—O—Al bonds are formed in an interfacial layer between the surface of the rolled aluminum-alloyed electrical strip and the pretreatment layer.

22. The coated electrical strip of claim 17, wherein the rolled aluminum-alloyed electrical strip has an Al content equal to or greater than 0.5% wt and equal to or less than 2.5% wt.
